(19) United States
(12) Patent Application Publication
(10) Pub. No.: US 2026/0042245 A1
(43) Pub. Date: Feb. 12, 2026

(54) METHOD OF MANUFACTURING COMPOSITE SILICONE DECORATIVE PIECE, COMPOSITE SILICONE DECORATIVE PIECE, AND SHOE COMPONENT

(71) Applicant: DAH LIH PUH CO., LTD., Taichung City (TW)

(72) Inventor: JUI-FEN SHIAO, Taichung City (TW)

(73) Assignee: DAH LIH PUH CO., LTD., Taichung City (TW)

(21) Appl. No.: 18/985,055

(22) Filed: Dec. 18, 2024

(30) Foreign Application Priority Data
Aug. 7, 2024 (TW) 113129582

(51) Int. Cl. B29C 45/14; B29K 83/00; B29K 675/00; B29L 31/50; B32B 25/08; B32B 25/20; B32B 27/40

(52) U.S. Cl. CPC B29C 45/1418; B32B 25/08; B32B 25/20; B32B 27/40; B29C 2045/14286; B29K 2083/00; B29K 2675/00; B29L 2031/50; B32B 2437/02

(57) ABSTRACT

A method of manufacturing a composite silicone decorative piece includes the following steps: providing a mold, placing a first heat-melting layer in a mold cavity of the mold to correspond to a placement area; injecting a liquid silicone to fill the mold cavity and cover the first heat-melting layer; laying the second heat-melting layer on the liquid silicone; heating the mold to connect the first heat-melting layer and the second heat-melting layer to the liquid silicone through heating and melting; cooling the mold to solidify the liquid silicone to form a silicone layer between the first heat-melting layer and the second heat-melting layer, thereby obtaining the composite silicone decorative piece. In another embodiment, a shoe component includes the composite silicone decorative piece is connected a shoe upper and an outsole, and the silicone layer is exposed on the shoe upper.

### BACKGROUND OF THE INVENTION

### Technical Field

The present invention relates generally to a decorative piece for shoe materials, and more particularly to a method of manufacturing a composite silicone decorative piece, a composite silicone decorative piece, and a shoe component.

### Description of Related Art

There are various decorative pieces designed on fabric surfaces of clothing, hats, and shoes. A decorative piece includes trademarks, words and patterns. Conventionally, the decorative piece is fixed on the fabric surfaces by sewing techniques.

Some manufacturers instead fix the decorative piece on the fabric surfaces by hot-pressing techniques, wherein the decorative piece is often made of Polyurethane (PU) heat-melt material, so that the PU decorative piece could be connected to the fabric surfaces through heating and melting. Although polyurethane (PU) is classified as an environmentally friendly material, Polyurethane (PU) still produces trace amounts of toxins, leading some consumers or manufacturers to avoid the use of polyurethane (PU).

Other manufacturers manufacture the decorative piece by using silicone material, wherein the silicone material is non-toxic, chemically stable, and the silicone material has high mechanical strength. However, a fiber material of conventional fabrics and the silicone decorative piece are typically different in chemical properties and cannot form interfacial polar compatibility. Therefore, it is difficult to attach the silicone decorative piece on the fabric surfaces. When the silicone decorative piece is applied to a shoe body, the solid silicone decorative piece cannot be directly adhered to a contact surface of an outsole of the shoe body. An adhesive needs to be applied between the solid silicone decorative piece and the fabric surfaces or the contact surface of the outsole to fix the solid silicone decorative piece on the fabric surfaces or the outsole. The adhesive is manually applied between the silicone decorative piece and the fabric surfaces or the outsole, which increases the cost of attaching the silicone decorative piece to the fabrics or the outsole. Moreover, the adhesive might damage a surface structure of the fabrics and a surface structure of the outsole.

Moreover, some manufacturers have designed a composite silicone decorative piece including a silicone layer, a heat-melting layer and a surface treatment agent between the silicone layer and the heat-melting layer. The silicone layer and the heat-melting layer are combined by the surface treatment agent to form the composite silicone decorative piece. However, a manufacturing process of the composite silicone decorative piece is to manually apply the surface treatment agent for connecting the silicone layer with the heat-melting layer, which not only reduces the efficiency of the process, but also endangers the health of workers.

### BRIEF SUMMARY OF THE INVENTION

In view of the above, the primary objective of the present invention is to provide a method of manufacturing a composite silicone decorative piece, a composite silicone decorative piece, and a shoe component. The method forms the composite silicone decorative piece at one time by hot-pressing with the mold 200, so that two heat-melting layers are connected to both sides of a silicone through heating and melting. In this way, the method not only enhances the manufacturing efficiency, but also avoids the use of chemical adhesives. Moreover, the composite silicone decorative piece could be fixed to any fabric or shoe component by using the two heat-melting layers, providing a rapid attachment effect.

The inventive subject matter provides a method of manufacturing a composite silicone decorative piece includes the following steps. Step S1: providing a mold, wherein the mold has a mold cavity, the mold cavity has a first cavity and a second cavity that communicate with each other, and the first cavity defines a placement area in the mold. Step S2: providing a first heat-melting layer, and placing the first heat-melting layer in the mold cavity of the mold to correspond to the placement area, wherein the first heat-melting layer is located in at least one of the first cavity or the second cavity. Step S3: injecting a liquid silicone from the second cavity into the mold cavity of the mold to fill the first cavity, wherein the liquid silicone fills the second cavity and covers the first heat-melting layer. Step S4: providing a second heat-melting layer, placing the second heat-melting layer in the second cavity of the mold, and laying the second heat-melting layer on the liquid silicone. Step S5: heating the mold to melt the first heat-melting layer and the second heat-melting layer in the mold cavity to connect the first heat-melting layer and the second heat-melting layer through heating and melting. Step S6: cooling the mold to solidify the first heat-melting layer and the second heat-melting layer and to solidify the liquid silicone to forma silicone layer between the first heat-melting layer and the second heat-melting layer, thereby obtaining the composite silicone decorative piece.

The inventive subject matter further provides a composite silicone decorative piece, including a silicone layer, a first heat-melting and a second heat-melting layer. The silicone layer having a first side and a second side opposite to the first side, wherein the silicone layer defines an installation area on the first side. The first heat-melting layer connected to the first side of the silicone layer and located in the installation area through heating and melting. The second heat-melting layer connected to the second side of the silicone layer through heating and melting.

The inventive subject matter further provides a shoe component, including a shoe upper, an outsole and the composite silicone decorative piece. The shoe upper having an outer peripheral surface. The outsole connected to a bottom of the shoe upper, the outsole having a circumferential side wall surrounding the outer peripheral surface of the shoe upper. The composite silicone decorative piece disposed between the shoe upper and the outsole, wherein the first heat-melting layer connected to the circumferential side wall of the outsole, the second heat-melting layer connected to the outer peripheral surface of the shoe upper, and the silicone layer is exposed on the shoe upper.

With the aforementioned design, the method of manufacturing the composite silicone decorative piece forms the composite silicone decorative piece at one time by hot-pressing with the mold, wherein the first heat-melting layer and the second heat-melting layer are co-molded and heated in the mold, so that each of the first heat-melting layer and the second heat-melting layer is in the molten state and is physically connected to the liquid silicone. The liquid silicone is solidified to form the silicone layer and is integrated with the first heat-melting layer and the second heat-melting layer into the composite silicone decorative piece with a layered structure. In this way, the method of manufacturing the composite silicone decorative piece not only enhances the manufacturing efficiency, but also avoids the use of chemical adhesives as the method of manufacturing the composite silicone decorative piece does not includes applying an adhesive between the first heat-melting layer and the silicone layer and between the second heat-melting layer and the silicone layer, so that the method of manufacturing the composite silicone decorative piece is environmentally friendly.

Moreover, the first side and the second side of the silicone layer of the composite silicone decorative piece are connected to first heat-melting layer and the second heat-melting layer. When the composite silicone decorative piece is attached to an article, such as a shoe component, the first heat-melting layer and the second heat-melting layer are respectively connected to the circumferential side wall of the outsole and the outer peripheral surface of the shoe upper, so that the composite silicone decorative piece is clamped and fixed between the shoe upper and the outsole, and patterns of the silicone layer could be exposed on the shoe upper of the shoe component as a decoration.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a perspective view of the composite silicone decorative piece of an embodiment according to the present invention;

FIG. 2 is an exploded view of the composite silicone decorative piece of the embodiment according to the present invention;

FIG. 3 is a side view of the composite silicone decorative piece of the embodiment according to the present invention;

FIG. 4 is a flowchart, showing the method of manufacturing the composite silicone decorative piece of an embodiment according to the present invention;

FIG. 5 is a perspective view of the mold of the method of manufacturing the composite silicone decorative piece of the embodiment according to the present invention;

FIG. 6 is a top view of the mold of the method of manufacturing the composite silicone decorative piece of the embodiment according to the present invention;

FIG. 7 is a sectional view taken along the 7-7 line in FIG. 6;

FIG. 8 is a schematic sectional view, showing the first heat-melting layer, the liquid silicone, and the second heat-melting layer are placed into the mold of the method of manufacturing the composite silicone decorative piece of the embodiment according to the present invention;

FIG. 9 is a schematic view, showing the composite silicone decorative piece is taken out from the mold of the method of manufacturing the composite silicone decorative piece of the embodiment according to the present invention;

FIG. 10 is a side view, showing the composite silicone decorative piece is applied to the shoe component of the embodiment according to the present invention;

FIG. 11 is a sectional view taken along the 11-11 line in FIG. 10; and

FIG. 12 is a partially enlarged view of a marked region A in FIG. 11.

### DETAILED DESCRIPTION OF THE INVENTION

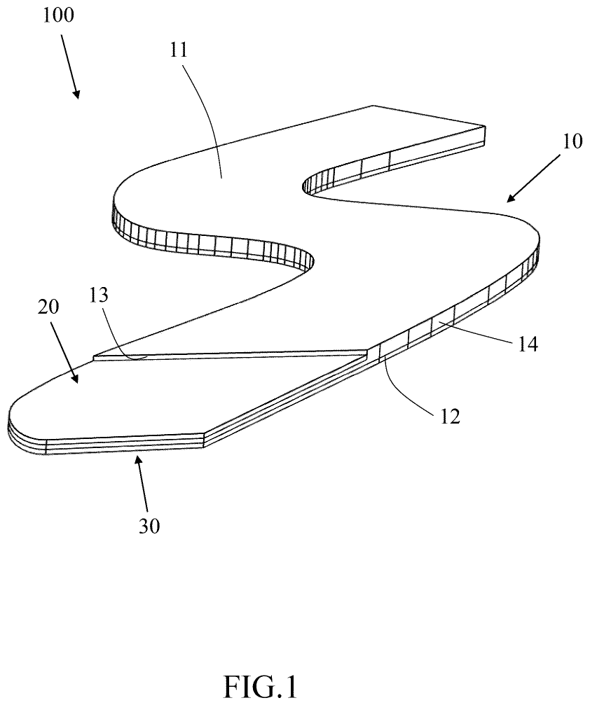

A composite silicone decorative piece 100 of an embodiment according to the present invention is illustrated in FIG. 1. The composite silicone decorative piece 100 includes a silicone layer 10, a first heat-melting layer 20, and a second heat-melting layer 30.

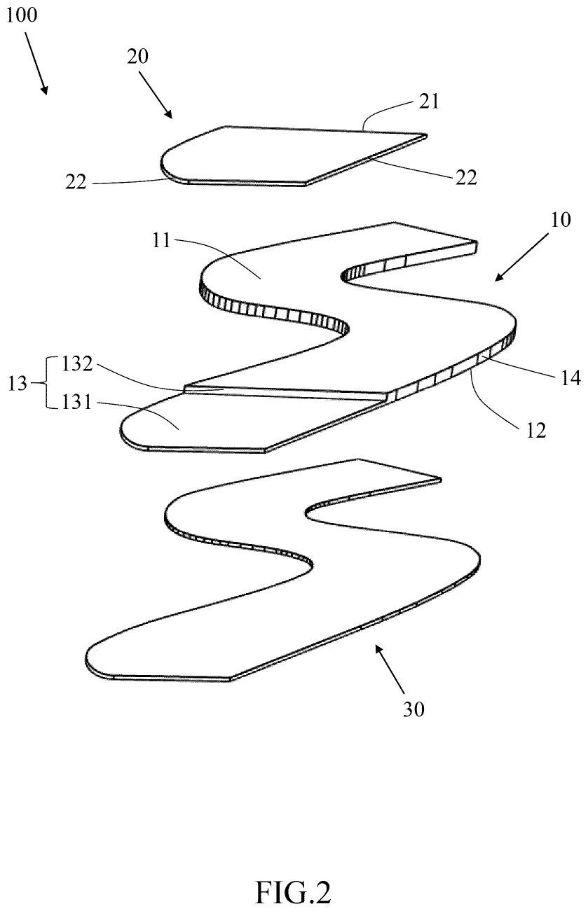

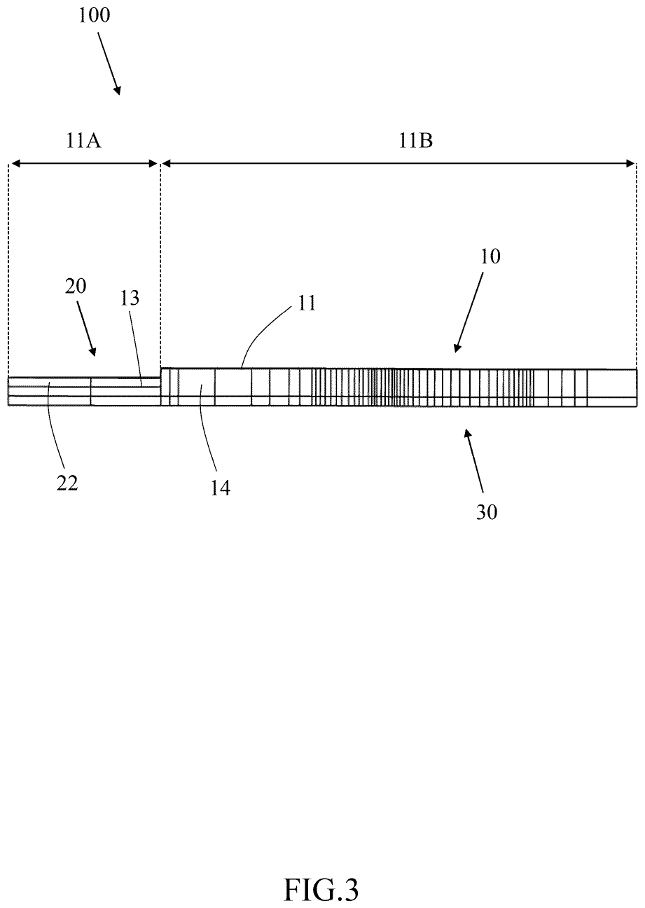

The silicone layer 10 has a first side 11 and a second side 12 opposite to the first side 11, and the silicone layer 10 defines an installation area 11A and an exposure area 11B on the first side 11. The exposure area 11B is adjacent to the installation area 11A. As illustrated in FIG. 2 and FIG. 3, in the current embodiment, the silicone layer 10 has a recess 13 corresponding to the installation area 11A. The recess 13 is opened around one end of the silicone layer 10. The recess 13 has a flat surface 131 and a side surface 132, where the flat surface 131 is recessed horizontally relative to the first side 11, indicating that the first side 11 is located on the exposure area 11B. The side surface 132 is connected between the flat surface 131 and the first side 11. The silicone layer 10 has a circumferential surface 14 located between the first side 11 and the second side 12 and connected to a perimeter of the flat surface 131. The second side 12 is a flat plane that corresponds to a shape of the silicone layer 10.

However, in other embodiments, the structure of the silicone layer 10 could be adjusted based on the required demand. For example, the silicone layer 10 is not limited to a S shape as shown in FIG. 2, and could be in other geometric shapes; the installation area 11A of the silicone layer 10 could be provided without the recess 13 (i.e., the installation area 11A and the exposure area 11B are at a same horizontal plane), as long as the installation area 11A could accumulate the first heat-melting layer 20; the recess 13 of the installation area 11A is not limited to the configuration that is opened around one end of the silicone layer 10, wherein the recess 13 could be changed to a groove.

The first heat-melting layer 20 is connected to the first side 11 of the silicone layer 10 and is located in the installation area 11A through heating and melting. In the current embodiment, a material of the first heat-melting layer 20 is thermoplastic polyurethane (TPU), and no surface treatment agent is provided between the first heat-melting layer 20 and the silicone layer 10, indicating that the first heat-melting layer 20 is heated to a molten state and is physically connected to the silicone layer 10. As illustrated in FIG. 2 and FIG. 3, the first heat-melting layer 20 is located in the recess 13 and does not protrude from the first side 11 in the exposure area 11B. The first heat-melting layer 20 has a contact wall 21 and a surrounding wall 22. The contact wall 21 is a flat surface and is located on one side of the first heat-melting layer 20. The surrounding wall 22 surrounds the first heat-melting layer 20 and is connected to two ends of the contact wall 21. When the first heat-melting layer 20 is connected to the flat surface 131 of the recess 13, the contact wall 21 abuts against the side surface 132 of the recess 13 and the surrounding wall 22 is aligned with the perimeter of the flat surface 131 and is flush with the circumferential surface 14 of the silicone layer 10, so that the first heat-melting layer 20 corresponds to a shape of the recess 13 and is connected to the installation area 11A of the silicone layer 10.

The second heat-melting layer 30 is connected to the second side 12 of the silicone layer 10 through heating and melting. In the current embodiment, a material of the second heat-melting layer 30 is the same as the material of the first heat-melting layer 20 to be thermoplastic polyurethane (TPU), and no surface treatment agent is provided between the second heat-melting layer 30 and the silicone layer 10. A connecting way between the second heat-melting layer 30 and the silicone layer 10 is similar to the connecting way between the first heat-melting layer 30 and the silicone layer 10 that the second heat-melting layer 30 is heated to a molten state and is physically connected to the silicone layer 10. As illustrated in FIG. 2 and FIG. 3, the second heat-melting layer 30 corresponds to a shape of the second side 12 and is laid flat on the silicone layer 10.

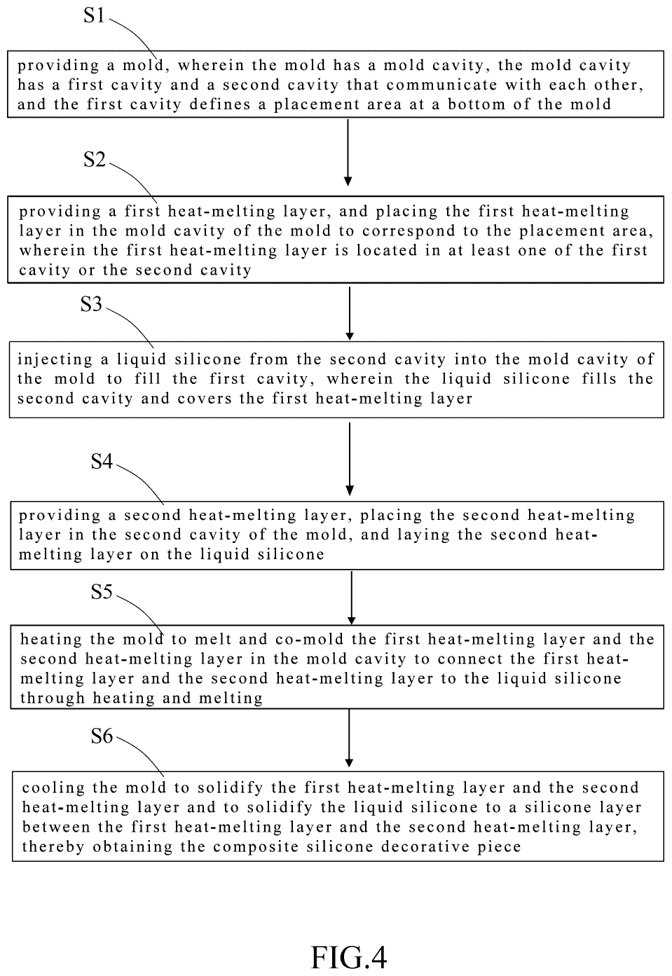

A method of manufacturing a composite silicone decorative piece of an embodiment according to the present invention is illustrated in FIG. 4. The method of manufacturing the composite silicone decorative piece is used to manufacture the composite silicone decorative piece 100 of the aforementioned embodiment and comprises the following steps:

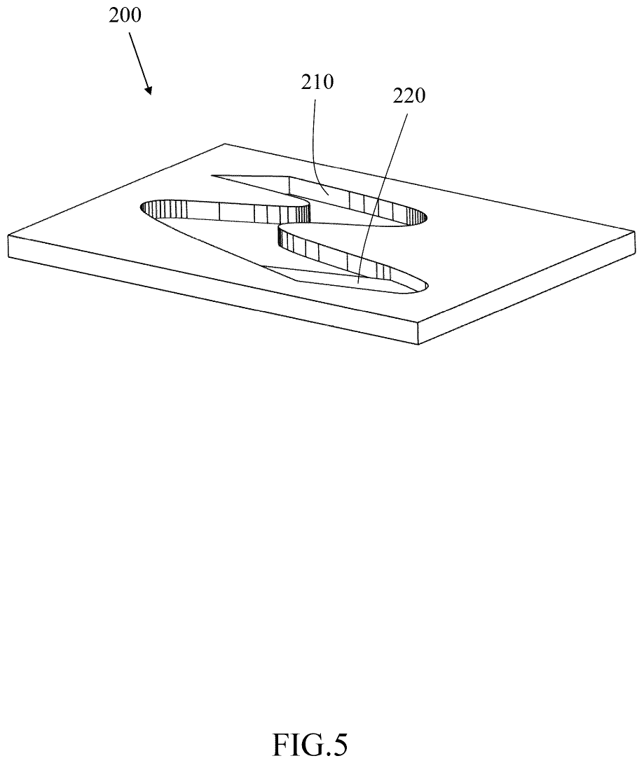

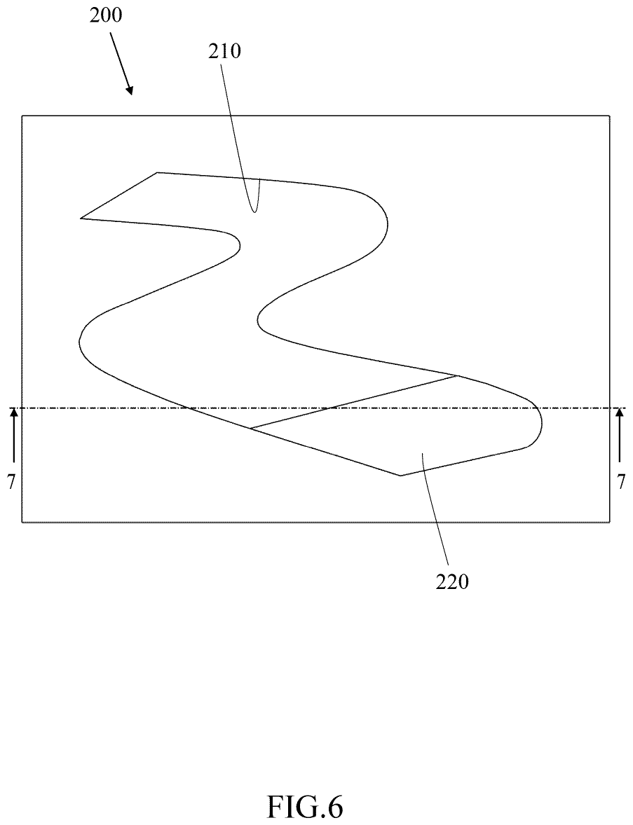

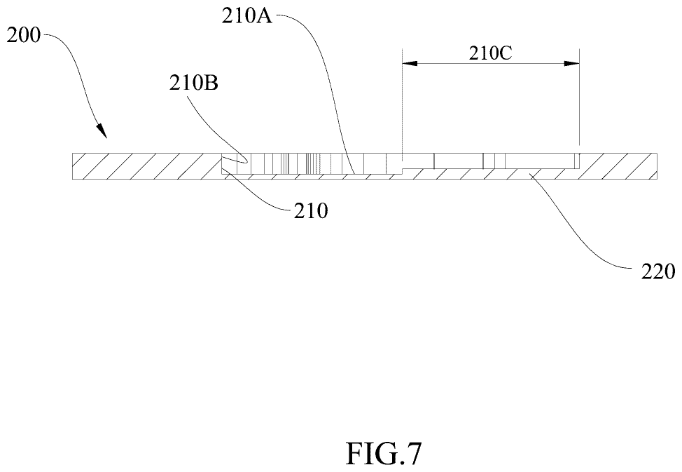

Step S1: providing a mold 200, wherein the mold 200 has a mold cavity 210; the mold cavity 210 has a first cavity 210A and a second cavity 210B that communicate with each other; the first cavity 210A defines a placement area 210C at a bottom of the mold 200. As illustrated in FIG. 5 to FIG. 7, in the current embodiment, the mold 200 has a protruding step portion 220 in the placement area 210C and located in the first cavity 210A, but not limited thereto; in other embodiments, the protruding step portion 220 in the placement area 210C could be changed to a groove, or the protruding step portion 220 could be omitted.

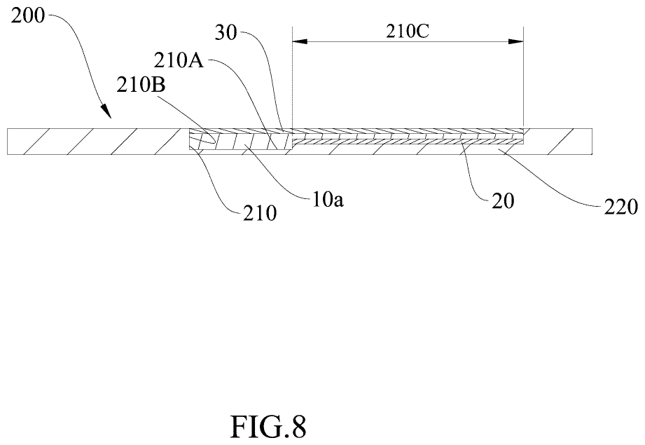

Step S2: providing the first heat-melting layer 20, and placing the first heat-melting layer 20 in the mold cavity 210 of the mold 200 to correspond to the placement area 210C, wherein the first heat-melting layer 20 is located in at least one of the first cavity 210A or the second cavity 210B. As illustrated in FIG. 8, in the current embodiment, the first heat-melting layer 20 is correspondingly placed on the protruding step portion 220 and located in the second cavity 210B.

Step S3: injecting a liquid silicone 10a from the second cavity 210B into the mold cavity 210 of the mold 200 to fill the first cavity 210A. As illustrated in FIG. 8, the liquid silicone 10a fills the second cavity 210B and covers the first heat-melting layer 20.

Step S4: providing the second heat-melting layer 30. As illustrated in FIG. 8, the second heat-melting layer 30 is placed in the second cavity 210B of the mold 200 and is laid on the liquid silicone 10a.

Step S5: heating the mold 200 to melt the first heat-melting layer 20 and the second heat-melting layer 30 to connect the first heat-melting layer 20 and the second heat-melting layer 30 to the liquid silicone in the mold cavity 210 through heating and melting, wherein the mold 200 is heated by a hot-pressing machine (not shown), and a heating temperature of the mold 200 is between 140° C. and 180° C.

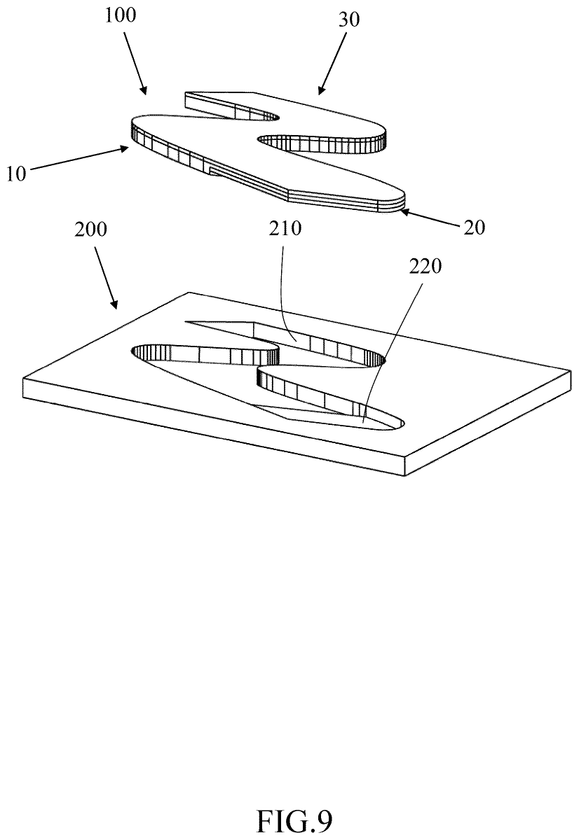

Step S6: cooling the mold 200 to solidify the first heat-melting layer 20 and the second heat-melting layer 30 and to solidify the liquid silicone 10a to form the silicone layer 10 between the first heat-melting layer 20 and the second heat-melting layer 30, thereby obtaining the composite silicone decorative piece 100 (as shown in FIG. 9).

Therefore, the method of manufacturing the composite silicone decorative piece forms the composite silicone decorative piece 100 at one time by hot-pressing with the mold 200, wherein the first heat-melting layer 20 and the second heat-melting layer 30 are co-molded and heated in the mold 200, so that each of the first heat-melting layer 20 and the second heat-melting layer 30 is in the molten state and is physically connected to the liquid silicone 10a. The liquid silicone 10a is solidified to form the silicone layer 10 and is integrated with the first heat-melting layer 20 and the second heat-melting layer 30 to form the composite silicone decorative piece 100 with a layered structure. In this way, the method of manufacturing the composite silicone decorative piece not only enhances the manufacturing efficiency, but also avoids the use of chemical adhesives as the method of manufacturing the composite silicone decorative piece does not includes applying an adhesive between the first heat-melting layer 20 and the silicone layer 10 and between the second heat-melting layer 30 and the silicone layer 10, so that the method of manufacturing the composite silicone decorative piece is environmentally friendly.

Moreover, the first side 11 and the second side 12 of the silicone layer 10 of the composite silicone decorative piece 100 are connected to first heat-melting layer 20 and the second heat-melting layer 30. When the composite silicone decorative piece 100 is attached to a decorative surface of an article, the first heat-melting layer 20 and the second heat-melting layer 30 of the composite silicone decorative piece 100 could be connected to the decorative surface of the article through heating and melting, and patterns of the silicone layer 10 could be exposed on the article, so that the structural design of the composite silicone decorative piece 100 facilitates the attachment of the composite silicone decorative piece 100 to the article as a decoration.

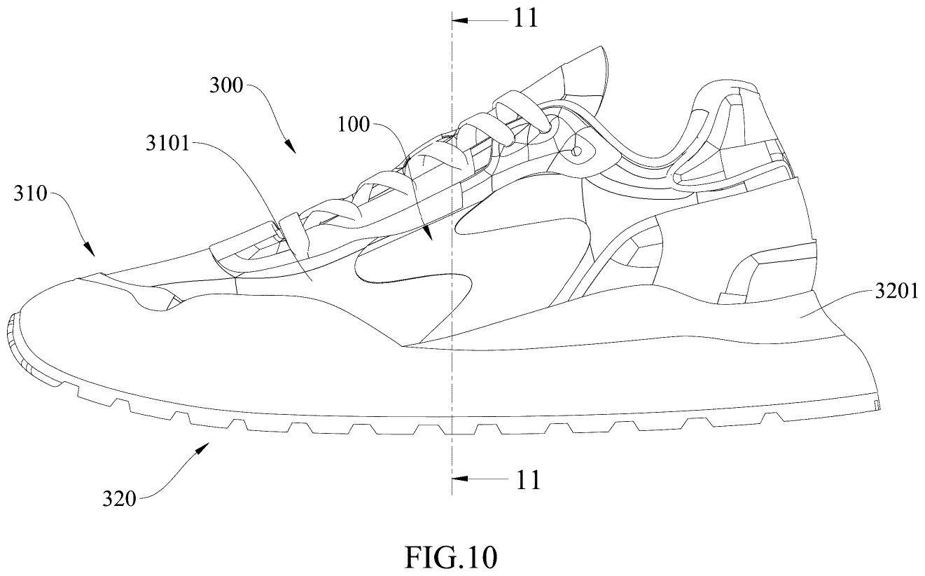

A shoe component 300 according to still another embodiment of the present invention is illustrated in FIG. 10. The shoe component 300 includes the composite silicone decorative piece 100 as an example. The shoe component 300 includes a shoe upper 310 and an outsole 320.

The shoe upper 310 has an outer peripheral surface 3101 and an attachment groove 3102. The attachment groove 3102 is located on a shoe quarter on the outer peripheral surface 3101 of the shoe upper 310 and corresponds to a shape of the composite silicone decorative piece 100. As illustrated in FIG. 10 to FIG. 12, the attachment groove 3102 has an open end 3102a and a closed end 3102b that are positioned opposite to each other. The open end 3102a faces the outsole 320. The shoe upper 310 further has a fixing portion 3103 on the outer peripheral surface 3101. The fixing portion 3103 correspondingly covers the closed end 3102b of the attachment groove 3102.

The outsole 320 is connected to a bottom of the shoe upper 310. The outsole 320 has a circumferential side wall 3201 surrounding the outer peripheral surface 3101 of the shoe upper 310. The open end 3102a of the attachment groove 3102 is covered by the circumferential side wall 3201.

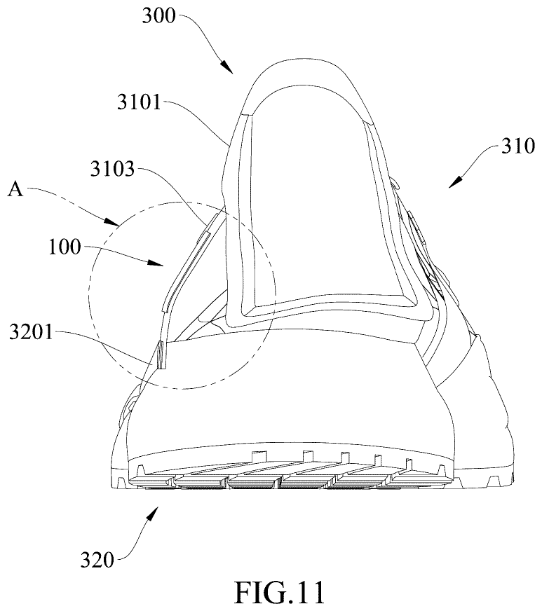

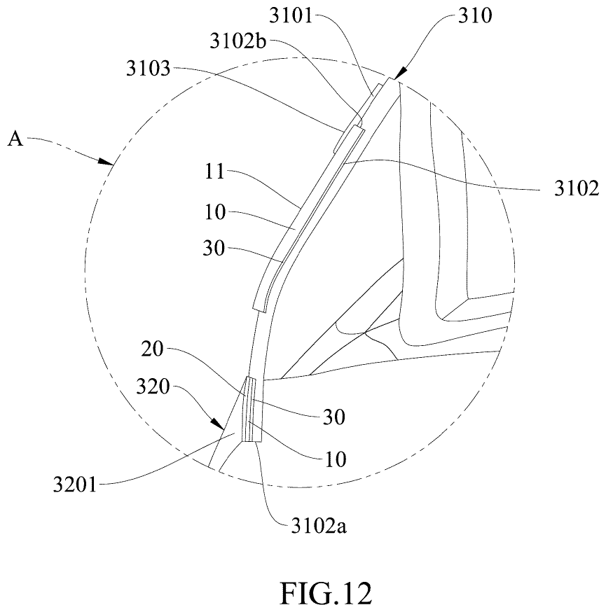

As illustrated in FIG. 10 and FIG. 11, the composite silicone decorative piece 100 is located between the shoe upper 310 and the outsole 320. The first heat-melting layer 20 of the composite silicone decorative piece 100 is connected to the circumferential side wall 3201 of the outsole 320, the second heat-melting layer 30 is connected to the outer peripheral surface 3101 of the shoe upper 310, and the silicone layer 10 is exposed on the shoe upper 310. Referring further to FIG. 11 and FIG. 12, in the current embodiment, the composite silicone decorative piece 100 is accommodated in the attachment groove 3102, wherein the first heat-melting layer 20 is located at the open end 3102a of the attachment groove 3102 and is connected to the circumferential side wall 3201 of the outsole 320 through heating and melting, the second heat-melting layer 30 is connected to the outer peripheral surface 3101 of the shoe upper 310 through heating and melting, no adhesive is provided between the first heat-melting layer 20 and the circumferential side wall 3201 and between the second heat-melting layer 30 and the outer peripheral surface 3101, the first side 11 of the silicone layer 10 is exposed on the attachment groove 3102. One end of the silicone layer 10 opposite to the first heat-melting layer 20 is in contact with the closed end 3102b of the attachment groove 3102 and is fixed by the fixing portion 3103, and a part of the first side 11 of the silicone layer 10 is covered by the fixing portion 3103.

Therefore, when the composite silicone decorative piece 100 is applied to the shoe component 300, the first heat-melting layer 20 and the second heat-melting layer 30 are respectively engaged with the circumferential side wall 3201 of the outsole 320 and the outer peripheral surface 3101 of the shoe upper 310, so that the composite silicone decorative piece 100 is clamped and fixed between the shoe upper 310 and the outsole 320, and no adhesive is provided while the composite silicone decorative piece 100 is applied on the shoe component 300, thereby saving the cost of applying the adhesive. The fixing portion 3103 of the shoe upper 310 tightly abuts against one end of the first side 11 of the silicone layer 10, further enhancing the securing effect of the composite silicone decorative piece 100 on the shoe upper 310. In this way, patterns of the silicone layer 10 could be exposed on the shoe upper 310 of the shoe component 300 as a decoration.

It must be pointed out that the embodiment described above is only a preferred embodiment of the present invention. All equivalent structures and methods which employ the concepts disclosed in this specification and the appended claims should fall within the scope of the present invention.

What is claimed is:

1. A method of manufacturing a composite silicone decorative piece, comprising:
step S1: providing a mold, wherein the mold has a mold cavity, the mold cavity has a first cavity and a second cavity that communicate with each other, and the first cavity defines a placement area in the mold;
step S2: providing a first heat-melting layer, and placing the first heat-melting layer in the mold cavity of the mold to correspond to the placement area, wherein the first heat-melting layer is located in at least one of the first cavity or the second cavity;
step S3: injecting a liquid silicone from the second cavity into the mold cavity of the mold to fill the first cavity, wherein the liquid silicone fills the second cavity and covers the first heat-melting layer;
step S4: providing a second heat-melting layer, placing the second heat-melting layer in the second cavity of the mold, and laying the second heat-melting layer on the liquid silicone;
step S5: heating the mold to melt the first heat-melting layer and the second heat-melting layer in the mold cavity to connect the first heat-melting layer and the second heat-melting layer to the liquid silicone through heating and melting; and
step S6: cooling the mold to solidify the first heat-melting layer and the second heat-melting layer and to solidify the liquid silicone to form a silicone layer between the first heat-melting layer and the second heat-melting layer, thereby obtaining the composite silicone decorative piece.

2. The method as claimed in claim 1, wherein the mold has a protruding step portion in the placement area, and the first heat-melting layer is correspondingly placed on the protruding step portion and located in the second cavity.

3. The method as claimed in claim 1, wherein a heating temperature of the mold is between 140° C. and 180° C., both a material of the first heat-melting layer and a material of the second heat-melting layer are thermoplastic polyurethane (TPU), and no surface treatment agent is provided between the first heat-melting layer and the silicone layer and between the second heat-melting layer and the silicone layer.

4. A composite silicone decorative piece, comprising:
a silicone layer having a first side and a second side opposite to the first side, wherein the silicone layer defines an installation area on the first side;
a first heat-melting layer connected to the first side of the silicone layer through heating and melting and located in the installation area; and
a second heat-melting layer connected to the second side of the silicone layer through heating and melting.

5. The composite silicone decorative piece as claimed in claim 4, wherein the silicone layer defines an exposure area adjacent to the installation area, the silicone layer has a recess corresponding to the installation area, the first heat-melting layer is located in the recess and does not protrude from the first side in the exposure area, and the second heat-melting layer corresponds to a shape of the second side and is laid flat over the second side.

6. The composite silicone decorative piece as claimed in claim 5, wherein the recess has a flat surface and a side surface connected between the flat surface and the first side, the silicone layer has a circumferential surface located between the first side and the second side and connected to a perimeter of the flat surface, the first heat-melting layer has a contact wall abutting against the side surface of the recess, the first heat-melting layer has a surrounding wall connected to two ends of the contact wall, when the first heat-melting layer is connected to the flat surface of the recess, the surrounding wall is aligned with the perimeter of the flat surface and is flush with the circumferential surface of the silicone layer.

7. The composite silicone decorative piece as claimed in claim 4, wherein both a material of the first heat-melting layer and a material of the second heat-melting layer are thermoplastic polyurethane (TPU), and no surface treatment agent is provided between the first heat-melting layer and the silicone layer and between the second heat-melting layer and the silicone layer.

8. A shoe component, comprising:
a shoe upper having an outer peripheral surface;
an outsole connected to a bottom of the shoe upper, the outsole having a circumferential side wall surrounding the outer peripheral surface of the shoe upper; and
the composite silicone decorative piece as claimed in claim 4, disposed between the shoe upper and the outsole, wherein the first heat-melting layer is connected to the circumferential side wall of the outsole, the second heat-melting layer is connected to the outer peripheral surface of the shoe upper, and the silicone layer is exposed on the shoe upper.

9. The shoe component as claimed in claim 8, wherein the shoe upper has an attachment groove on the outer peripheral surface that corresponds to a shape of the composite silicone decorative piece, the composite silicone decorative piece is accommodated in the attachment groove, the first heat-melting layer is connected to the circumferential side wall through heating and melting, the second heat-melting layer is connected to the outer peripheral surface through heating and melting, no adhesive is provided between the first heat-melting layer and the circumferential side wall and between the second heat-melting layer and the outer peripheral surface, and the first side of the silicone layer is exposed on the attachment groove.

10. The shoe component as claimed in claim 9, wherein the attachment groove has an open end and a closed end that are positioned opposite to each other, the open end faces the outsole and is covered by the circumferential side wall, the shoe upper has a fixing portion on the outer peripheral surface correspondingly covering the closed end, when the composite silicone decorative piece is accommodated in the attachment groove, the first heat-melting layer is located at the open end and connected to the circumferential side wall, one end of the silicone layer opposite to the first heat-melting layer is in contact with the closed end and fixed by the fixing portion, and a part of the first side of the silicone layer is covered by the fixing portion.
